(19) United States
(12) Patent Application Publication
(10) Pub. No.: US 2016/0353096 A1
(43) Pub. Date: Dec. 1, 2016

(54) DISPLAY DEVICE AND IMAGE QUALITY SETTING METHOD

(71) Applicant: SEIKO EPSON CORPORATION, Tokyo (JP)

(72) Inventors: Mitsunori TOMONO, Suwa-Gun (JP); Yoshiyuki KANAMORI, Sapporo-Shi (JP); Makoto SHIGEMITSU, Sapporo-Shi (JP)

(73) Assignee: SEIKO EPSON CORPORATION, Tokyo (JP)

(21) Appl. No.: 15/161,607

(22) Filed: May 23, 2016

(30) Foreign Application Priority Data
May 29, 2015 (JP) 2015-109842

(51) Int. Cl. H04N 13/04; H04N 5/44

(52) U.S. Cl. CPC H04N 13/0452; H04N 5/4401; H04N 5/4403

(57) ABSTRACT

A display device includes a video signal acquisition unit adapted to obtain a video signal, a display unit adapted to display an image represented by the video signal, a communication unit adapted to establish connection to an information processing device to perform communication with the information processing device, a transmission unit adapted to transmit information related to a plurality of interactive setting images having alternatives for setting an image quality of the image to the information processing device, a reception unit adapted to receive the alternative selected by a user in the setting image in the information processing device, and a setting unit adapted to set the image quality in accordance with the alternative received by the reception unit and a type of the video signal.

### CROSS-REFERENCE

The entire disclosure of Japanese Patent Application No. 2015-109842 filed May 29, 2015 is expressly incorporated by reference herein.

### BACKGROUND

1. Technical Field

The present invention relates to a technology for operating electronic equipment from another device.

2. Related Art

As an invention for operating an electronic apparatus using a mobile terminal, there is cited a mobile terminal disclosed in, for example, JP-A-2012-253716 (Document 1). In the mobile terminal, when a TV viewer application is run, and the mobile terminal is connected to a wireless LAN, the mobile terminal displays a remote control picture on a touch panel. By operating the remote control picture displayed on the touch panel, reproduction of a recorded program stored in a server and tuning in a television system can be performed.

The display device for displaying an image is provided with a function of performing an adjustment of the image quality, displays a menu picture for performing the adjustment of the image quality when a button of the main body or the remote controller is operated, and performs the adjustment of the image quality in accordance with an operation performed on the menu picture. By using the technology disclosed in Document 1 on such a display device, the adjustment of the image quality can be performed with the mobile terminal connected to the display device.

In the case in which the display device is provided with a plurality of adjustment items, a variety of adjustments can be performed. However, if the number of items increases, it becomes difficult for the user not familiar with each of the adjustment items to achieve an optimal setting.

### SUMMARY

An advantage of some aspects of the invention is to provide a technology of making it possible to obtain an image quality suitable for the user without individually adjusting a variety of adjustment items by the user.

An aspect of the invention provides a display device including a video signal acquisition unit adapted to obtain a video signal, a display unit adapted to display an image represented by the video signal, a communication unit adapted to establish connection to an information processing device to perform communication with the information processing device, a transmission unit adapted to transmit information related to a plurality of interactive setting images having alternatives for setting an image quality of the image to the information processing device, a reception unit adapted to receive the alternative selected by a user in the setting image in the information processing device, and a setting unit adapted to set the image quality in accordance with the alternative received by the reception unit and a type of the video signal.

According to the display device of this aspect of the invention, an image quality suitable for the user can be obtained without individually adjusting a variety of adjustment items by the user.

The aspect of the invention may be configured such that the image quality set by the setting unit is different between a case in which the type of the video signal is a 2D-image and a case in which the type of the video signal is a 3D-image even if the alternative received by the reception unit is the same.

According to this configuration, it is possible to set the image quality suitable for the 2D image and the image quality suitable for the 3D image.

The aspect of the invention may be configured such that the reception unit receives the alternative transmitted by the information processing device every time the selection of the alternative ends in one of the setting images, and the setting unit sets the image quality in accordance with the alternative received every time the reception unit receives the alternative.

According to this configuration, it is possible to perform the confirmation of the image quality corresponding to the alternative every time the alternative for setting the image quality is selected.

The aspect of the invention may be configured such that the display device further includes a storage unit adapted to store a history of the alternative selected for each of the setting images, and a change unit adapted to change a content of the setting image in accordance with the history.

According to this configuration, it is possible to easily set the image quality of user's choice.

The aspect of the invention may be configured such that the change unit changes an order in which the alternatives are arranged.

According to this configuration, it is possible to easily set the image quality of user's choice.

Another aspect of the invention provides an image quality setting method of a display device including a video signal acquisition unit adapted to obtain a video signal, a display unit adapted to display an image represented by the video signal, and a communication unit adapted to establish connection to an information processing device to perform communication with the information processing device, the method comprising, the method including transmitting information related to a plurality of interactive setting images having alternatives for setting an image quality of the image to the information processing device, receiving the alternative selected by a user in the setting image in the information processing device, and setting the image quality in accordance with the alternative received in the step of receiving the alternative selected by the user and a type of the video signal.

According to the image quality setting method of this aspect of the invention, an image quality suitable for the user can be obtained without individually adjusting a variety of adjustment items by the user.

### BRIEF DESCRIPTION OF THE DRAWINGS

The invention will be described with reference to the accompanying drawings, wherein like numbers reference like elements.

FIG. 1 is a diagram showing a device related to a display system 1 according to an embodiment of the invention.

FIG. 2 is a diagram showing a hardware configuration of a projector 10.

FIG. 3 is a functional block diagram of a function realized in the projector 10.

FIG. 4 is a diagram showing a hardware configuration of an information processing device 20.

FIG. 5 is a functional block diagram of a function realized in the information processing device 20.

FIG. 6 is a sequence chart for describing an operation example of the embodiment.

FIG. 7 is a diagram showing an example of a picture displayed by the information processing device 20.

FIG. 8 is a diagram showing an example of a display picture of a search result of the projector 10.

FIG. 9 is a diagram showing an example of a picture displayed by the information processing device 20 when establishing connection.

FIG. 10 is a diagram showing an example of a GUI image displayed by the information processing device 20.

FIG. 11 is a sequence chart of an operation example of switching OFF the power of a projector 10A.

FIG. 12 is a sequence chart of an operation example of switching OFF the power of a projector 10B.

FIG. 13 is a diagram showing an example of a picture displayed by the information processing device 20 when establishing connection.

FIG. 14 is a sequence chart of an operation example of switching OFF the power of a projector 10C.

FIG. 15 is a diagram showing an example of the GUI image displayed by the information processing device 20.

FIG. 16 is a sequence chart of an operation example of interactively setting an image quality.

FIG. 17 is a diagram showing an example of a picture displayed when interactively setting the image quality.

FIG. 18 is a diagram showing an example of the picture displayed when interactively setting the image quality.

FIG. 19 is a diagram showing an example of the picture displayed when interactively setting the image quality.

FIG. 20 is a diagram showing an example of the picture displayed when interactively setting the image quality.

FIG. 21 is a diagram showing an example of the picture displayed when interactively setting the image quality.

FIG. 22 is a diagram showing an example of the picture displayed when interactively setting the image quality.

FIG. 23 is a sequence chart of an operation example of restoring the image quality, which has interactively been set, to a state having not been changed.

FIG. 24 is a sequence chart of an operation example in the case of storing the image quality having interactively been set.

FIG. 25 is a sequence chart of an operation example in the case of not storing the image quality having interactively been set.

### DESCRIPTION OF AN EXEMPLARY EMBODIMENT

### Embodiment

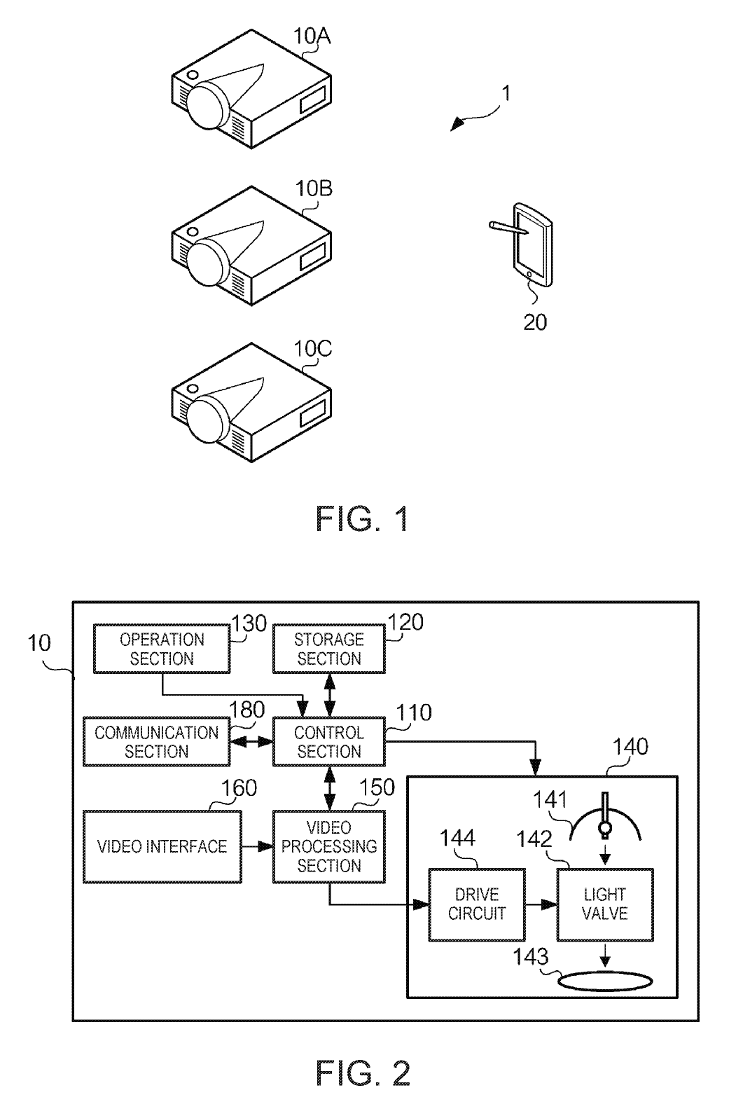

FIG. 1 is a diagram showing a device related to a display system 1 according to an embodiment of the invention. Projectors 10A through 10C are each an example of a display device for projecting an image represented by a picture signal supplied from an external device and an image represented by image data obtained from an external device on a screen or a wall surface. Hereinafter, in the case in which it is unnecessary to distinguish the projectors 10A through 10C from each other, each of the projectors 10A through 10C is referred to as a projector 10. An information processing device 20 according to the present embodiment is a so-called smartphone. The information processing device 20 stores an application program provided with a function of controlling the projectors 10A through 10C. The information processing device 20 executing the application program is connected to either of the projectors 10A through 10C with wireless communication to control the connected projector in accordance with an operation by the user. In other words, the information processing device 20 executes the application program to function as a remote controller for operating the projector 10.

### Configurations of Projectors 10A Through 10C

FIG. 2 is a diagram showing a hardware configuration of each of the projectors 10A through 10C. In the present embodiment, basic hardware configurations of the projectors 10A through 10C are the same, and in the case in which it is necessary to distinguish the sections of the projectors 10A through 10C from each other, the description will hereinafter be presented with the reference symbols of the sections of the projector 10A suffixed with “A,” the reference symbols of the sections of the projector 10B suffixed with “B,” and the reference symbols of the sections of the projector 10C suffixed with “C” for the sake of convenience of description, and in the case in which it is unnecessary to distinguish the sections from each other, the description will hereinafter be presented with the suffixes of “A,” “B,” and “C” to the reference symbols omitted.

The projector 10 is provided with a control section 110, a storage section 120, an operation section 130, and a projection section 140. Further, the projector 10 is provided with a video processing section 150, a video interface 160, and a communication section 180.

The control section 110 is a microcomputer provided with a central processing unit (CPU), a read only memory (ROM), and a random access memory (RAM). In the projector 10A, when the CPU executes a program stored in the ROM, the control section 110A controls each of the sections to realize a function of projecting an image, a function of establishing communication with an external device, a function (hereinafter referred to as a server function) of a server device in a client-server system, a “network standby” function, and so on.

The network standby function is a function of supplying the control section 110 and the communication section 180 with the power to make it possible to communicate with an external device even in the case of switching OFF the power of the projector 10 using a power button of the operation section 130A or the remote controller in the state in which the power can be supplied to the projector 10 via a power cord, an AC adapter, or the like. In the case of setting the function to an enable state, there is set the state in which the power is supplied to the control section 110A and the communication section 180A even in the case of switching OFF the power of the projector 10A by the power button of the operation section 130A, the power button of the remote controller, or the control by the information processing device 20. Further, in the case of setting the function to a disable state, there is set the state in which the power is supplied to the control section 110A, but is not supplied to the communication section 180A in the case of switching OFF the power of the projector 10A by the power button of the operation section 130A, the power button of the remote controller, or the control by the information processing device 20.

It should be noted that in the present embodiment, the program stored in the ROM of the control section 110B realizes the server function, but is different from the program of the control section 110A in the point that the network standby function is not realized, and the program stored in the ROM of the control section 110C is different from the program of the control section 110A in the point that both of the server function and the network standby function are not realized.

The storage section 120 stores setting related to the image quality of the image to be projected, and information related to settings of a variety of functions. The operation section 130 is provided with a plurality of buttons for operating the projector 10. By the control section 110 controlling each of the sections in accordance with the button having been operated, an adjustment of the picture to be projected, settings of a variety of functions provided to the projector 10, and so on are performed. Further, the operation section 130 is provided with a light receiving section (not shown) for receiving an infrared signal from a remote controller (not shown). The operation section 130 converts the infrared signal transmitted from the remote controller into an electric signal to supply the control section 110, and then the control section 110 controls each of the sections in accordance with the signal supplied.

The communication section 180 has a communication interface for wired communication, a communication interface for wireless communication compliant with the standard of IEEE 802.11, a communication interface of Bluetooth (registered trademark), a communication interface of USB (Universal Serial Bus), and so on, and performs communication with other computers using the variety of interfaces. The communication section 180 is an example of a communication device for achieving connection to perform communication with the projector 10.

The video interface 160 is an example of a video signal acquisition device for obtaining a video signal. The video interface 160 has connectors for RCA, D-sub, HDMI (registered trademark), and so on, and supplies the video processing section 150 with the video signal supplied from the external device to the connectors. The video processing section 150 obtains the video signal supplied from the video interface 160. Further, the video processing section 150 obtains a signal of an on-screen image such as a GUI (Graphical User Interface) or a menu for operating the projector 10 from the control section 110. The video processing section 150 is provided with a variety of image processing functions, and performs image processing on the video signal supplied from the video interface 160 to adjust the image quality of the image to be projected. The video processing section 150 supplies the projection section 140 with the video signal adjusted in image quality. Further, in the case in which the video processing section 150 is supplied with the signal of the on-screen image from the control section 110, the video processing section 150 supplies the projection section 140 with the video signal on which the signal of the on-screen image is superimposed.

The projection section 140 for projecting the image includes a light source 141, alight valve 142, a drive circuit 144, and a projection optical system 143. The light source 141 is a lamp for emitting light, and the light emitted by the light source 141 is dispersed by a plurality of dichroic mirrors and mirrors not shown into light beams of red, green, and blue, and the light beams of red, green, and blue obtained by the dispersion are guided to the light valve 142. It should be noted that the light source 141 can also be a light emitting diode or a semiconductor laser device for emitting a laser beam instead of the lamp.

The drive circuit 144 obtains the video signal supplied from the video processing section 150. The video signal supplied to the drive circuit 144 includes grayscale data representing a grayscale of a red component in the image to be projected, grayscale data representing a grayscale of a green component in the image to be projected, and grayscale data representing a grayscale of a blue component in the image to be projected. The drive circuit 144 extracts the grayscale data of each of the colors of red, green, and blue to drive the light valve 142 based on the grayscale data of each color thus extracted.

The light valve 142 includes a liquid crystal light valve to which the red light beam described above is input, a liquid crystal light valve to which the green light beam described above is input, and a liquid crystal light valve to which the blue light beam described above is input. The liquid crystal light valves are each a transmissive liquid crystal panel, and are each provided with pixels arranged in a matrix with a plurality of rows and a plurality of columns. The liquid crystal light valve to which the red light beam is input is driven based on the red grayscale data, the liquid crystal light valve to which the green light beam is input is driven based on the green grayscale data, and the liquid crystal light valve to which the blue light beam is input is driven based on the blue grayscale data. In each of the liquid crystal light valves, the drive circuit 144 controls each of the pixels to vary the transmittance of the pixel. By controlling the transmittance of the pixels, the light beams of the respective colors having been transmitted through the respective liquid crystal light valves form the images corresponding to the respective grayscale data. The images of the light beams of red, green, and blue having been transmitted through the respective liquid crystal light valves are combined with each other by a dichroic prism not shown, and then enter the projection optical system 143. The projection optical system 143 is an optical system for enlarging the image having entered the projection optical system 143, and projects the image having entered the projection optical system 143 in an enlarged manner using a lens or a mirror.

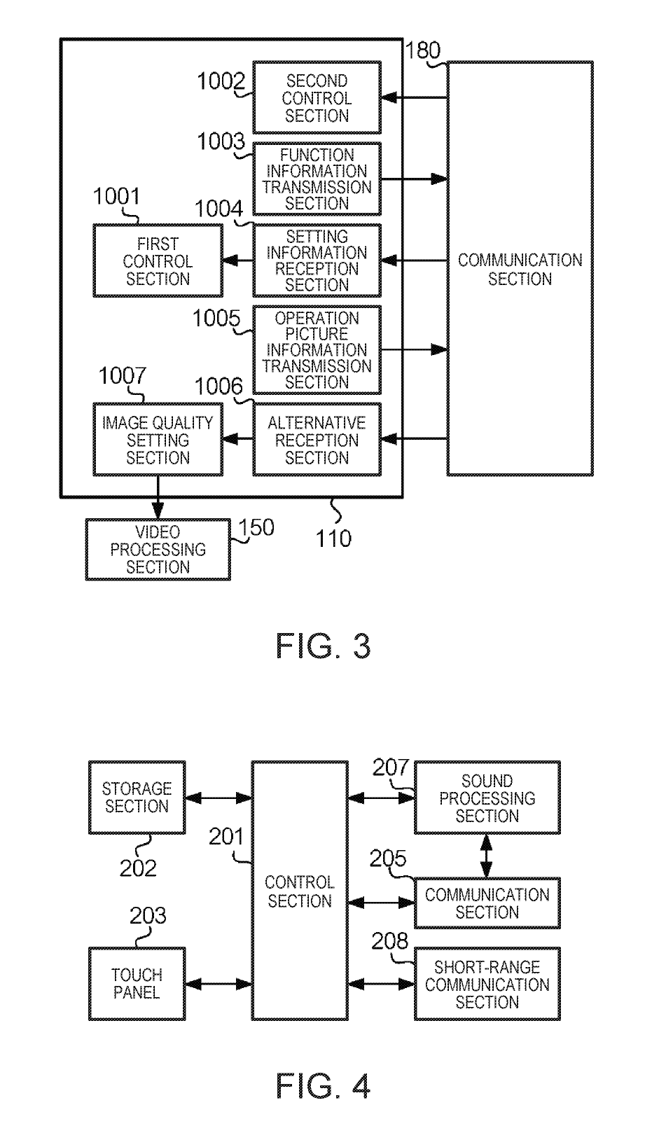

FIG. 3 is a functional block diagram of the projector 10 showing a configuration of the functions realized by the control section 110 executing the program in the ROM.

A first control section 1001 is an example of a first control device for controlling the power supply to the communication section 180 in accordance with a setting state of the network standby function. The first control section 1001 supplies the communication section 180 with the power even if the power of its own device is in the OFF state by controlling the power source not shown in the case in which the network standby function is in the enable state, and stops the supply of the power to the communication section 180 by controlling the power source not shown when the power of its own device is in the OFF state in the case in which the network standby function is in the disable state.

A second control section 1002 is an example of a second control device for switching ON or OFF the power of its own device. The second control section 1002 controls the power source not shown to switch ON or OFF the power of its own device in the case in which the power is supplied to the communication section 180, and the communication section 180 has received a command for switching ON or OFF the power of its own device.

The function information transmission section 1003 is an example of a function information transmission device for transmitting the function information representing the functions provided to the projector 10 to the information processing device 20.

A setting information reception section 1004 is an example of a setting information reception device for receiving the setting information for enabling or disabling the network standby function from the information processing device 20.

An operation picture information transmission section 1005 is an example of an operation picture information transmission device for transmitting the operation picture information as the data of the GUI image for operating the projector 10. Further, the operation picture information transmission section 1005 is also an example of a transmission device for transmitting the data of the GUI image as a setting image for setting the image quality of the image projected by the projector 10.

An alternative reception section 1006 is an example of an alternative reception device for receiving the information representing the alternative selected by the user out of the alternatives included in the setting image for setting the image quality.

An image quality setting section 1007 is an example of a setting device for controlling the video processing section 150 in accordance with the alternative received by the alternative reception device to set the image quality of the image to be projected.

### Configuration of Information Processing Device 20

FIG. 4 is a diagram showing an example of a hardware configuration of the information processing device 20. The control section 201 is provided with a CPU, a RAM, and a nonvolatile memory, and by the CPU executing the program stored in the nonvolatile memory, an operating system of the smartphone functions.

The touch panel 203 is a device having the display device (e.g., a liquid crystal display) and a sensor for detecting a contact with the finger on the display surface of the display device combined with each other, and an example of the operation section to be operated by the user. The touch panel 203 displays characters, the GUI, a menu picture for operating the information processing device 20, and so on using a display device. Further, the touch panel 203 detects the position touched by the user with a finger using a sensor. The control section 201 identifies the position detected by the touch panel 203 and the operation of the user in accordance with the picture displayed on the touch panel, and then executes control of each of the sections and a variety of processes in accordance with the operation thus identified.

A sound processing section 207 has a microphone and a speaker. In the case in which the information processing devices 20 make a voice call with each other, when a digital signal related to a voice of the communication partner is supplied from a communication section 205, the sound processing section 207 converts the digital signal into an analog signal. The analog signal is supplied to the speaker, and the voice of the communication partner is output from the speaker. Further, when the microphone picks up the voice, the sound processing section 207 converts the voice thus picked up into a digital signal. In the case of making a voice call with the information processing device 20, the sound processing section 207 supplies the digital signal obtained by converting the voice of the user to the communication section 205. The digital signal is transmitted from the communication section 205 to a mobile communication network, and is then transmitted to the information processing device 20 of the communication partner.

A short-range communication section 208 has a communication interface for wireless communication compliant with the standard of IEEE 802.11. The short-range communication section 208 receives a radio wave for the wireless communication transmitted from an external device with an antenna, and then supplies the control section 201 with a signal represented by the radio wave thus received. Further, when the signal representing the information to be transmitted to the external device is supplied from the control section 201, the short-range communication section 208 transmits the radio wave representing the signal supplied from the control section 201 from the antenna.

In the case in which the short-range communication section 208 performs communication with the projector 10, the short-range communication section 208 directly establishes the communication without intervention of a wireless LAN router or a communication network, but can also establish the communication with the projector 10 via the wireless LAN router or the communication network.

A storage section 202 is a nonvolatile memory, and stores a variety of application programs and the data used by the application programs. In the present embodiment, the storage section 202 stores an application program (hereinafter referred to as a control application) for making the information processing device 20 function as a controller of the projector 10.

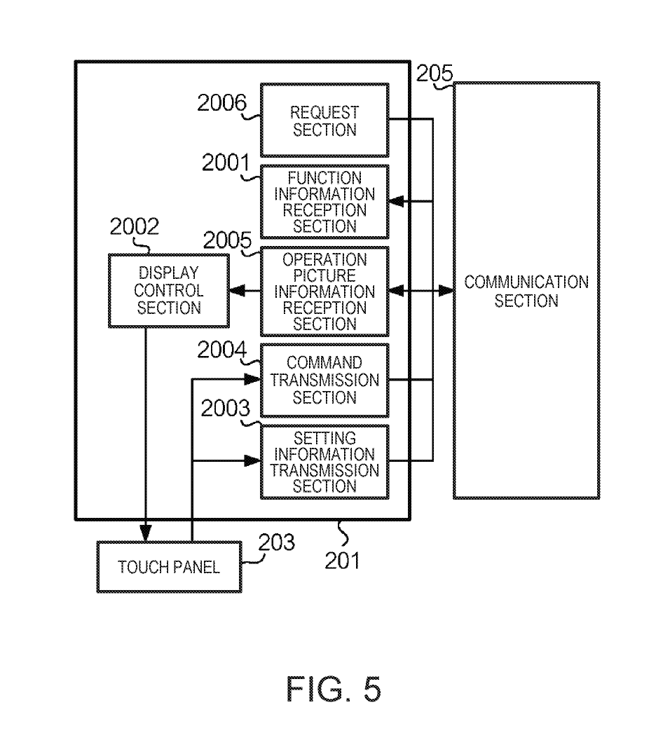

FIG. 5 is a functional block diagram of the information processing device 20 showing a configuration of the functions realized by the control section 201 executing the control application.

A request section 2006 is an example of a request device for requesting the function information representing the functions provided to the projector 10 to the projector 10.

A function information reception section 2001 is an example of a function information reception device for receiving the function information representing the functions provided to the projector 10 from the projector 10.

An operation picture information reception section 2005 is an example of an operation picture information reception device for receiving operation picture information for displaying a GUI image as an operation picture for operating the projector 10, and an operation picture for setting the image quality of the image to be projected by the projector 10.

The display control section 2002 controls the touch panel 203 so that the GUI image as the operation picture corresponding to the operation picture information received by the operation picture information reception section 2005 is displayed. The display control section 2002 is an example of a display control device for displaying the GUI image.

A setting information transmission section 2003 is an example of a setting information transmission device for transmitting the setting information for enabling or disabling the network standby function to the projector 10 in accordance with an operation having been performed in the touch panel 203.

A command transmission section 2004 is an example of a command transmission device for transmitting a command for switching ON or OFF the power of the projector 10 to the projector 10 in accordance with an operation performed on the GUI image.

### Operation Example of Embodiment

Then, there are described an operation example in the case of connecting the information processing device 20 and the projector 10 to each other with wireless communication using the control application, an operation example in the case of controlling the power of the projector 10 using the information processing device 20 connected with the wireless communication, and an operation example in the case of changing the image quality of the image to be projected by the projector 10 using the information processing device 20 connected with the wireless communication.

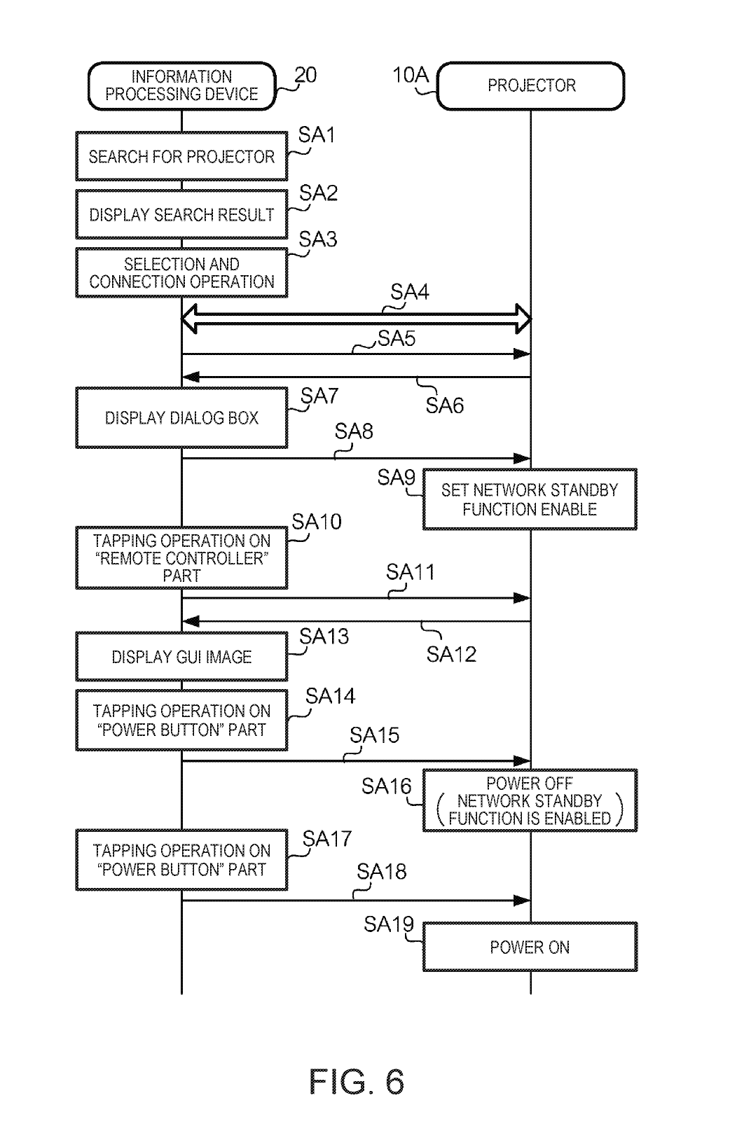

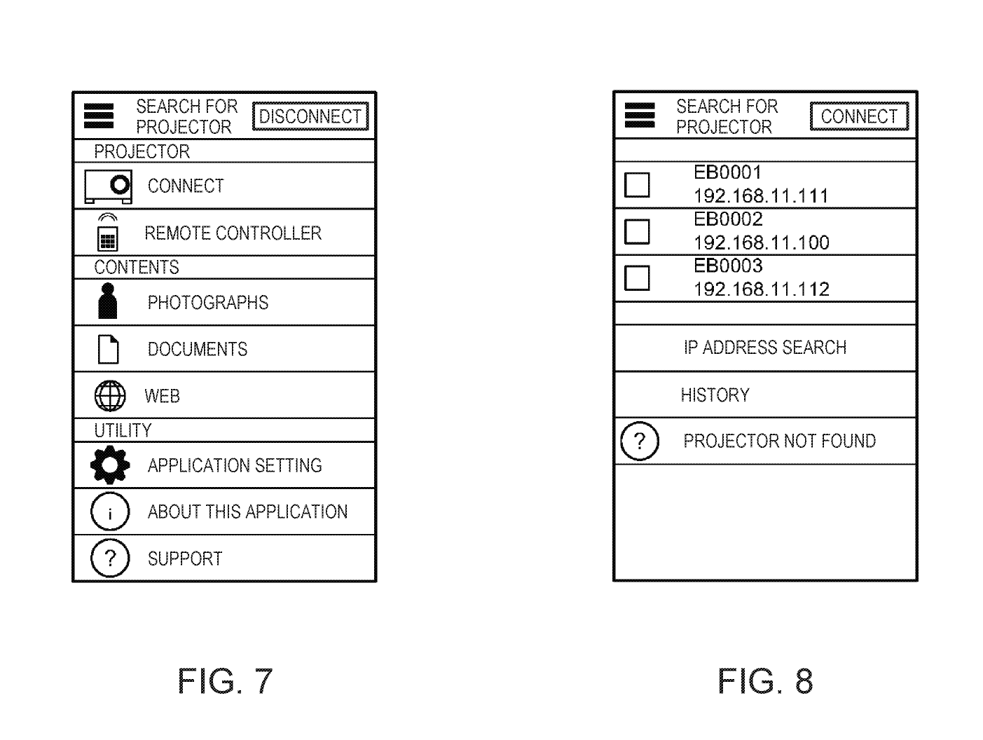

FIG. 6 is a sequence chart for describing the operation in the case of operating the projector 10A using the information processing device 20 executing the control application. Further, FIG. 7 is a diagram showing an example of a picture displayed by the information processing device 20 executing the control application.

When the user performs an operation of tapping a part corresponding to “SEARCH FOR PROJECTOR” in FIG. 7 in the touch panel 203, the control section 201 controls the short-range communication section 208 to search (step SA1) for the projector 10 capable of establishing connection of the communication. As a method of searching for the projector 10, there can be adopted, for example, a technology disclosed in JP-A-2006-196946. When the search for the connectable projector 10 ends, the control section 201 controls (step SA2) the touch panel 203 so that the picture of the search result is displayed.

FIG. 8 is a diagram showing an example of a picture for displaying the search result. In FIG. 8, there is illustrated the case in which the projector 10A through the projector 10C have been found. In FIG. 8, the IP address and the identifier of the projector 10A are shown in the first line of the search result, the IP address and the identifier of the projector 10B are shown in the second line, and the IP address and the identifier of the projector 10C are shown in the third line.

When the user performs an operation of switching ON the checkbox in the line, in which the IP address and the identifier of the projector 10A are displayed, in the touch panel 203, and then performs (step SA3) an operation of tapping the “connection” button located on the upper right side, the control section 201 controls the short-range communication section 208 to perform the wireless communication to establish (step SA4) the connection of the communication with the projector 10A.

When the connection to the projector 10A is established, the control section 201 transmits (step SA5) a message for making an inquiry about the functions provided to the projector 10A to the projector 10A. When the communication section 180A receives the message, the control section 110A transmits (step SA6) function information representing the functions provided to the projector 10A to the information processing device 20. Since the projector 10A is provided with the server function and the network standby function as described above, the function information transmitted here from the projector 10A to the information processing device 20 includes information representing the server function and information representing the network standby function.

When the short-range communication section 208 receives the function information transmitted from the projector 10A, the control section 201 obtains the function information received by the short-range communication section 208. When the control section 201 obtains the function information, the control section 201 controls (step SA7) the touch panel 203 so that there is displayed a dialog box for notifying the user of the fact that the connection to the projector 10 has been established. When displaying the dialog box, the control section 201 determines whether or not the information representing the network standby function is included in the function information thus obtained. In the case in which the function information thus obtained includes the information representing the network standby function, the control section 201 controls the touch panel 203 so that there is displayed a checkbox for making an inquiry to the user about whether or not the user uses the remote control function even in the case in which the projector 10 is powered OFF.

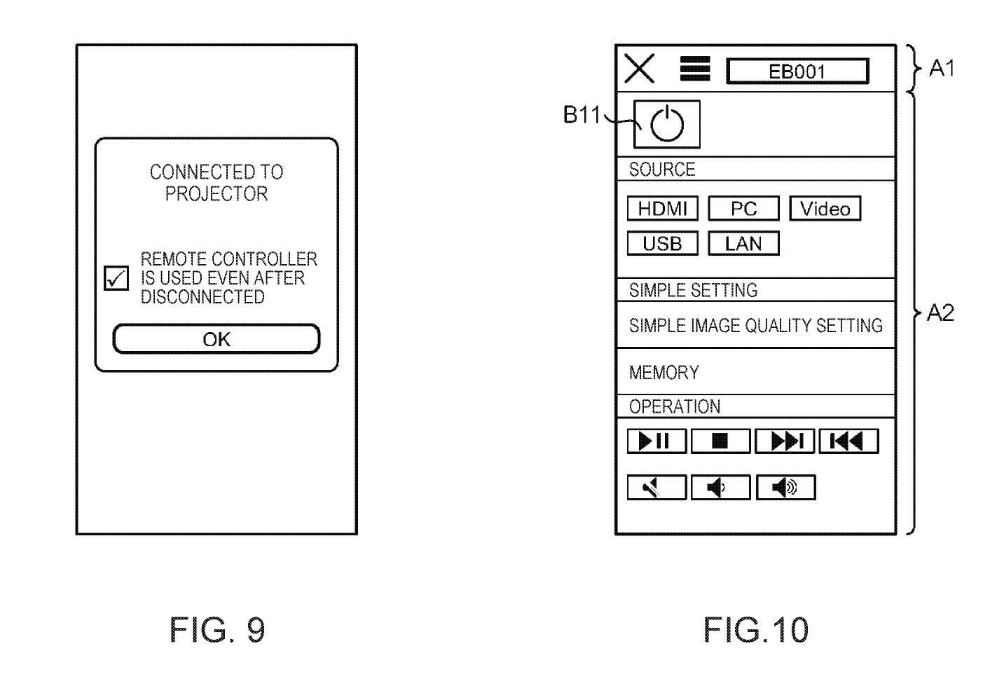

FIG. 9 is a diagram showing an example of a dialog box displayed here by the information processing device 20. When the user performs an operation of switching ON the checkbox displayed on the touch panel 203, and performs an operation of tapping the “OK” button located in the dialog box, the control section 201 transmits (step SA8) a command for enabling the network standby function to the projector 10A. When the transmission of the command ends, the control section 201 controls the touch panel 203 so that the menu picture shown in FIG. 7 is displayed.

When the communication section 180A receives the command for enabling the network standby function, the control section 110A obtains the command having been received by the communication section 180A. When the control section 110A obtains the command, the control section 110A sets (step SA9) the network standby function to the enable state.

Then, when the user performs (step SA10) an operation of tapping a part corresponding to “REMOTE CONTROLLER” in the touch panel 203 displaying the picture shown in FIG. 7, the control section 201 determines whether or not the information representing the server function is included in the function information having been transmitted in the step SA6. As described above, the function information having been transmitted from the projector 10A includes the information representing the server function. In this case, the control section 201 controls the short-range communication section 208 to transmit (step SA11) a message, which requests the data of the GUI image as an example of the operation image for operating the projector, to the projector 10A.

When the communication section 180A receives the message for requesting the data of the GUI image, the control section 110A obtains the message having been received by the communication section 180A. When the control section 110A obtains the message for requesting the data of the GUI image, the control section 110A controls the communication section 180A to transmit (step SA12) the data of the GUI image for operating the projector 10A to the information processing device 20. In the present embodiment, the data of the GUI image is described using the HTML (Hyper Text Markup Language).

When the short-range communication section 208 receives the data of the GUI image transmitted from the projector 10A, the control section 201 obtains the data received by the short-range communication section 208. The control section 201 generates the GUI image in accordance with the data thus obtained, and then controls (step SA13) the touch panel 203 so that the GUI image thus generated is displayed.

FIG. 10 is a diagram showing an example of the GUI image displayed here on the touch panel 203. In FIG. 10, the display area A1 is an area for displaying an image (common operation picture) of control provided in advance as a resource to the control application, and the display area A2 is an area for displaying a picture generated in accordance with the data (an example of second common operation picture information) of the GUI image. In the display area A1, there is displayed the identifier of the projector 10 connected. The GUI of the buttons in the display area A2 can be realized by, for example, button tags of the HTML.

When the user performs (step SA14) an operation of tapping the power button B11 displayed on the touch panel 203, the control section 201 obtains a character string described in the value attribute of the button tag corresponding to the power button B11 in the HTML data of the GUI image. For example, the character string of “power” is made to correspond to the power button B11 here as the value attribute. The character string is an example of the command for switching ON or OFF of the power of the projector 10. The control section 201 controls the short-range communication section 208 to transmit (step SA15) the character string thus obtained to the projector 10A.

When the communication section 180A receives the character string of “power” transmitted from the information processing device 20, the control section 110A obtains the character string received by the communication section 180A. When the control section 110A obtains the character string of “power,” the control section 110A switches OFF the power to stop the power supply to the video processing section 150 and the projection section 140 in the case in which the power of its own device is in the ON state, but does not stop (step SA16) the supply of the power to the communication section 180A in the case in which the network standby function is set to the enable state. Therefore, even if the power is switched OFF in the projector 10A, the connection of the communication remains established between the projector 10A and the information processing device 20.

Then, when the user performs (step SA17) the operation of tapping the power button B11 displayed on the touch panel 203, the control section 201 obtains the character string described in the value attribute of the button tag corresponding to the power button B11 in the HTML data of the GUI image. The control section 201 controls the short-range communication section 208 to transmit (step SA18) the character string (“power”) thus obtained to the projector 10A.

When the communication section 180A receives the character string of “power” transmitted from the information processing device 20, the control section 110A obtains the character string received by the communication section 180A. When the control section 110A obtains the character string of “power,” the control section 110A switches ON the power to perform (step SA19) the supply of the power to the sections to which the power supply has been stopped in the case in which the power of its own device is in the OFF state.

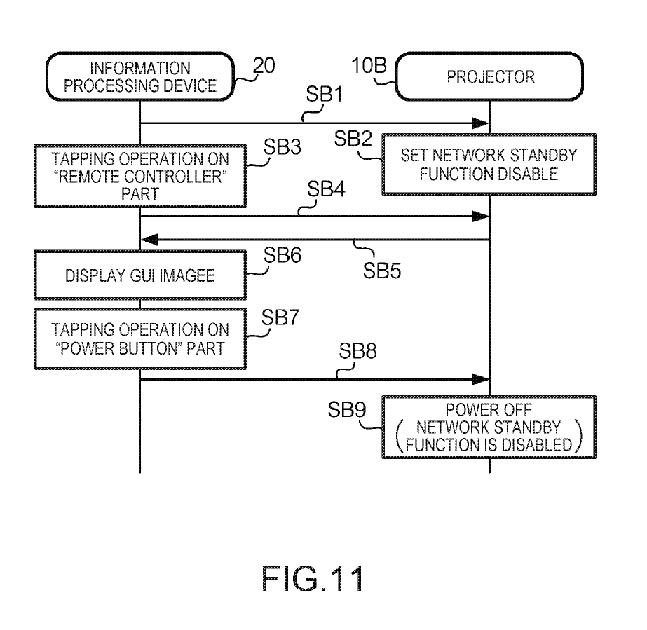

Then, an operation example of the case in which the network standby function is disabled will be described using a sequence chart shown in FIG. 11. It should be noted that in the following description, the operation example is described assuming that the process corresponding to the step SA1 through the step SA7 has already been performed.

In the picture shown in FIG. 9, when the user performs the operation of switching OFF the checkbox displayed on the touch panel 203, and performs the operation of tapping the “OK” button located in the dialog box, the control section 201 transmits (step SB1) a command for disabling the network standby function to the projector 10A. When the transmission of the command ends, the control section 201 controls the touch panel 203 so that the picture shown in FIG. 7 is displayed.

When the communication section 180A receives the command for disabling the network standby function, the control section 110A obtains the command having been received by the communication section 180A. When the control section 110A obtains the command, the control section 110A sets (step SB2) the network standby function to the disable state.

Then, when the user performs (step SB3) an operation of tapping a part corresponding to “REMOTE CONTROLLER” on the touch panel 203 displaying the picture shown in FIG. 7, the information processing device 20 and the projector 10A perform the communication with each other, the same process as in the step SA11 through the step SA13 of the operation example described above is performed (step SB4 through step SB6), and the picture shown in FIG. 10 is displayed on the touch panel 203.

When the user performs (step SB7) the operation of tapping the power button B11 displayed on the touch panel 203, the control section 201 obtains the character string described in the value attribute of the button tag corresponding to the power button B11 in the HTML data of the GUI image. The control section 201 controls the short-range communication section 208 to transmit (step SB8) the character string (“power”) thus obtained to the projector 10A.

When the communication section 180A receives the character string of “power” transmitted from the information processing device 20, the control section 110A obtains the character string received by the communication section 180A. When the control section 110A obtains the character string of “power,” the control section 110A switches OFF the power to stop the supply of the power to the video processing section 150 and the projection section 140 in the case in which the power of its own device is in the ON state. Further, when the control section 110A obtains the character string of “power,” the control section 110A also stops (step SB9) the supply of the power to the communication section 180A in the case in which the network standby function is set to the disable state. Since the power supply to the communication section 180A is stopped, the connection of the communication between the projector 10A and the information processing device 20 is cut. When the connection to the projector 10A is cut, the control section 201 controls the touch panel 203 so that the picture shown in FIG. 7 is displayed.

As described above, in the case in which the user sets the network standby function to the disable state, since the power supply to the communication section 180A is stopped when switching OFF the power, the wireless communication compliant with the standard of IEEE 802.11 is disabled in the projector 10A, and it becomes unachievable for the information processing device 20 to power ON the projector using the wireless communication. In this case, in order to power ON the projector 10A, the user operates the power button of the remote controller or the operation section 130A to power ON the projector 10A.

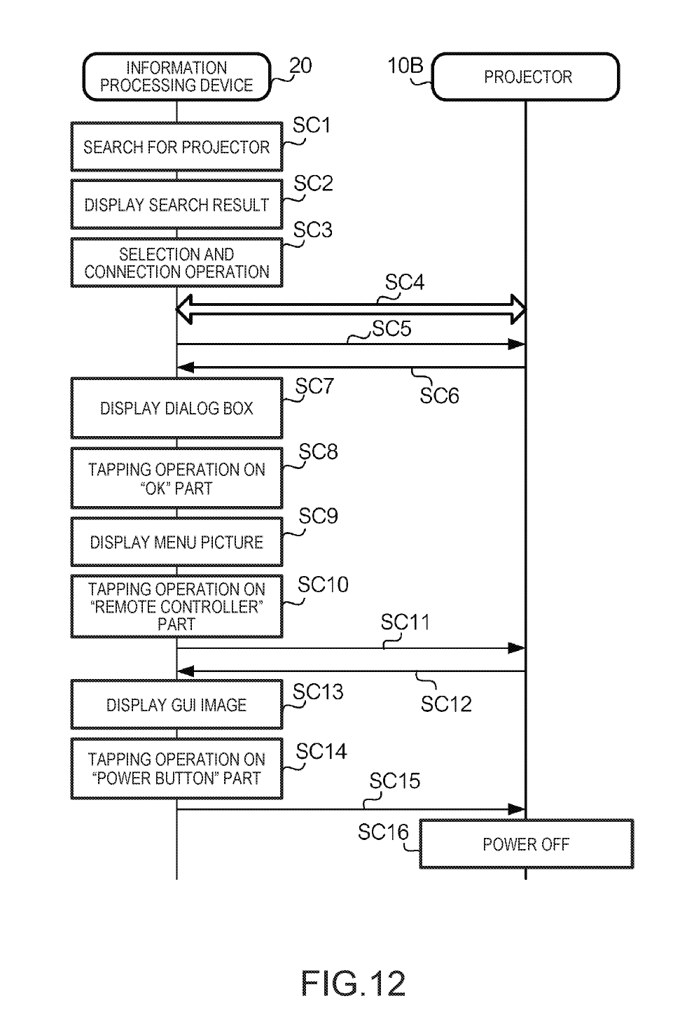

Then, an operation example of the case in which the information processing device 20 is connected to the projector 10B not provided with the network standby function will be described using a sequence chart shown in FIG. 12. It should be noted that in the following description, the operation example is described assuming that the same process (step SC1 and step SC2) as the process corresponding to the step SA1 and the step SA2 has already been performed.

When the user performs an operation of switching ON the checkbox in the line, in which the IP address and the identifier of the projector 10B are displayed, in the touch panel 203, and then performs (step SC3) the operation of tapping the “connection” button located on the upper right side in the state in which the picture shown in FIG. 8 is displayed, the control section 201 controls the short-range communication section 208 to perform the wireless communication to establish (step SC4) the connection of the communication with the projector 10B.

When the connection to the projector 10B is established, the control section 201 transmits (step SC5) a message for making an inquiry about the functions provided to the projector 10B to the projector 10B. When the communication section 180B receives the message, the control section 110B transmits (step SC6) the function information representing the functions provided to the projector 10B to the information processing device 20. Since the projector 10B is provided with the server function but is not provided with the network standby function as described above, it results that the function information transmitted here to the information processing device 20 includes the information representing the server function but does not include the information representing the network standby function.

When the short-range communication section 208 receives the function information transmitted from the projector 10B, the control section 201 obtains the function information received by the short-range communication section 208. When the control section 201 obtains the function information, the control section 201 controls (step SC7) the touch panel 203 so that there is displayed a dialog box for notifying the user of the fact that the connection to the projector 10 has been established. When displaying the dialog box, the control section 201 determines whether or not the information representing the network standby function is included in the function information thus obtained. In the case in which the function information thus obtained does not include the information representing the network standby function, the control section 201 controls the touch panel 203 so that the checkbox for making an inquiry to the user about whether or not the user uses the remote control function even in the case in which the projector is powered OFF is not displayed.

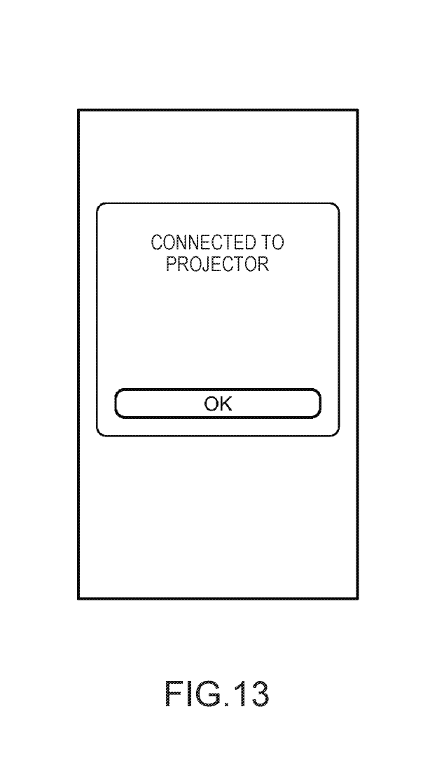

FIG. 13 is a diagram showing an example of a dialog box displayed here by the information processing device 20. When the user performs (step SC8) an operation of tapping the “OK” button located in the dialog box, the control section 201 controls (step SC9) the touch panel 203 so that the menu picture shown in FIG. 7 is displayed. Then, when the user performs (step SC10) the operation of tapping the part corresponding to “REMOTE CONTROLLER” in the touch panel 203 displaying the picture shown in FIG. 7, the control section 201 determines whether or not the information representing the server function is included in the function information obtained in the step SC6. As described above, the function information obtained from the projector 10B includes the information representing the server function. In this case, the control section 201 controls the short-range communication section 208 to transmit (step SC11) the message, which requests the data of the GUI image for operating the projector, to the projector 10B.

The operation (step SC12, step SC13) performed after the information processing device 20 transmits the message for requesting the data of the GUI image and until the information processing device 20 obtains the data of the GUI image, and then displays the GUI image in accordance with the data thus obtained is the same as in the operation example described above in which the connection to the projector 10A is established, and therefore, the description thereof will be omitted.

Then, when the user performs (step SC14) the operation of tapping the power button B11 displayed in the state in which the picture shown in FIG. 10 is displayed on the touch panel 203, the control section 201 obtains the character string described in the value attribute of the button tag corresponding to the power button B11 in the HTML data of the GUI image. The control section 201 controls the short-range communication section 208 to transmit (step SC15) the character string (“power”) thus obtained to the projector 10B.

When the communication section 180B receives the character string of “power” transmitted from the information processing device 20, the control section 110B obtains the character string received by the communication section 180B. When the control section 110B obtains the character string of “power,” the control section 110B switches OFF the power to stop the supply of the power to the video processing section 150 and the projection section 140 in the case in which the power of its own device is in the ON state. Further, the control section 110B also stops (step SC16) the supply of the power to the communication section 180B since its own device is not provided with the network standby function. Since the power supply to the communication section 180B is stopped, the connection of the communication between the projector 10B and the information processing device 20 is cut. When the connection to the projector 10B is cut, the control section 201 controls the touch panel 203 so that the picture shown in FIG. 7 is displayed.

In the case in which the connection to the projector 10B not provided with the network standby function is established as described above, since the power supply to the communication section 180B is stopped when switching OFF the power, it becomes unachievable for the projector 10B to perform the wireless communication compliant with the standard of IEEE 802.11, and it becomes unachievable for the information processing device 20 to power ON the projector 10B using the wireless communication. In this case, in order to power ON the projector 10B, the user operates the power button of the remote controller or the operation section 130B to power ON the projector 10B.

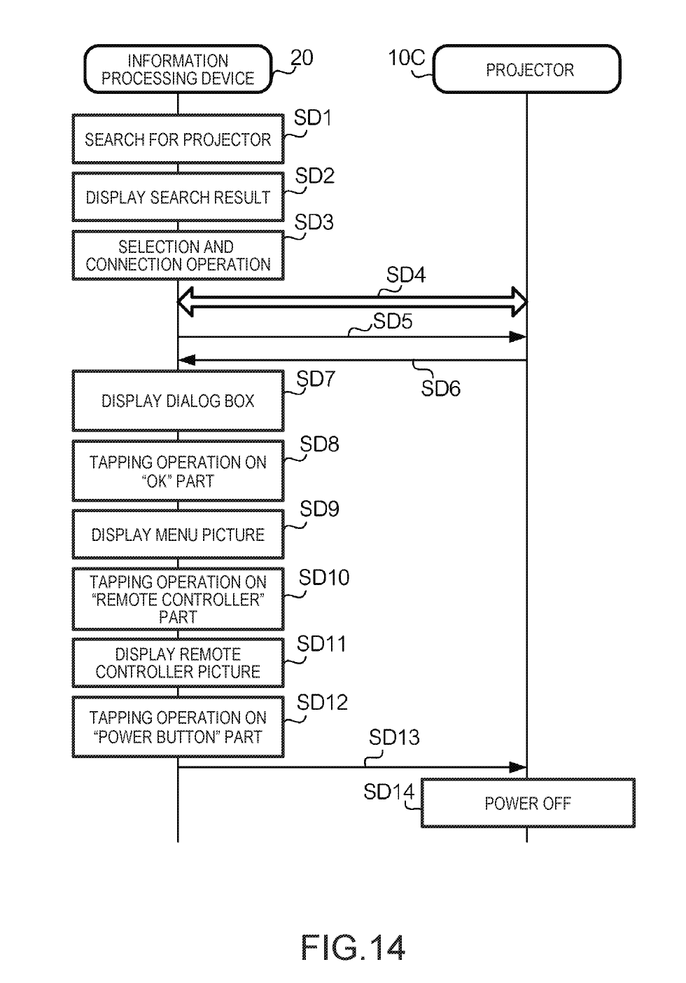

Then, an operation example of the case in which the information processing device 20 is connected to the projector 10C not provided with the server function and the network standby function will be described using a sequence chart shown in FIG. 14. It should be noted that in the following description, the operation example is described assuming that the same process (step SD1 and step SD2) as the process corresponding to the step SA1 and the step SA2 has already been performed.

When the user performs an operation of switching ON the checkbox in the line, in which the IP address and the identifier of the projector 10C are displayed, in the touch panel 203, and then performs (step SD3) the operation of tapping the “connection” button located on the upper right side in the state in which the picture shown in FIG. 8 is displayed, the control section 201 controls the short-range communication section 208 to perform the wireless communication to establish (step SD4) the connection of the communication with the projector 10C.

When the connection to the projector 10C is established, the control section 201 transmits (step SD5) a message for making an inquiry about the functions provided to the projector 10C to the projector 10C. When the communication section 180C receives the message, the control section 110C transmits (step SD6) the function information representing the functions provided to the projector 10C to the information processing device 20. Since the projector 10C is not provided with the server function and the network standby function as described above, it results that the function information transmitted here to the information processing device 20 does not include the information representing the server function and the information representing the network standby function.

When the short-range communication section 208 receives the function information transmitted from the projector 10C, the control section 201 obtains the function information received by the short-range communication section 208. When the control section 201 obtains the function information, the control section 201 controls (step SD7) the touch panel 203 so that there is displayed a dialog box for notifying the user of the fact that the connection to the projector 10 has been established. When displaying the dialog box, the control section 201 determines whether or not the information representing the network standby function is included in the function information thus obtained. In the case in which the function information thus obtained does not include the information representing the network standby function, the control section 201 controls the touch panel 203 so that the checkbox for making an inquiry to the user about whether or not the user uses the remote control function even in the case in which the projector is powered OFF is not displayed.

When the user performs (step SD8) an operation of tapping the “OK” button located in the dialog box, the control section 201 controls (step SD9) the touch panel 203 so that the menu picture shown in FIG. 7 is displayed. Then, when the user performs (step SD10) the operation of tapping the part corresponding to “REMOTE CONTROLLER” in the touch panel 203 displaying the picture shown in FIG. 7, the control section 201 determines whether or not the information representing the server function is included in the function information obtained in the step SD6. As described above, the function information obtained from the projector 10C does not include the information representing the server function. In this case, the control section 201 controls (step SD11) the touch panel 203 so that there is displayed an operation picture corresponding to common operation picture information provided in advance to the control application as a resource. As described above, since the control application is stored in the storage section 202, the common operation picture information provided in advance to the control application as a resource is also stored in the storage section 202. In other words, the storage section 202 is an example of a storage device for storing the common operation picture information. Further, the first common operation picture information is an example of the common operation picture information stored in the storage section 202.

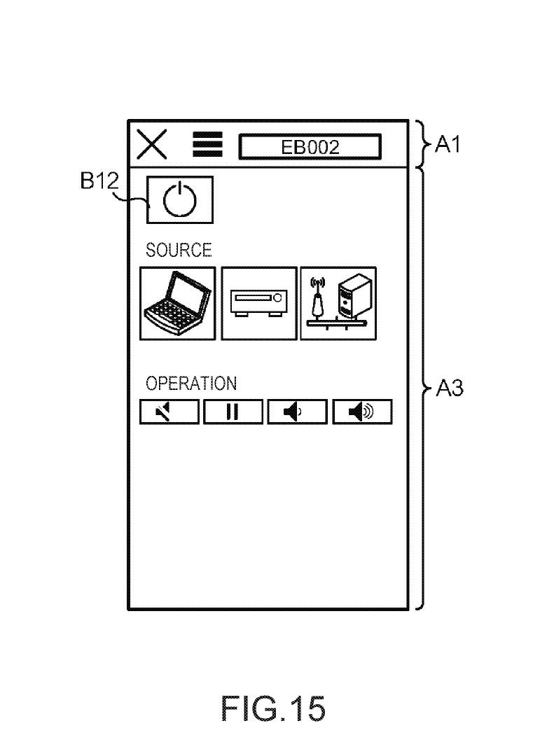

FIG. 15 is a diagram showing an example of the GUI image displayed here on the touch panel 203. In FIG. 15, the display area A3 is an area for displaying an image of buttons provided in advance to the control application as a resource. Here, in the GUI image displayed, there are displayed the buttons for operations common to the projectors 10A through 10C such as switching ON/OFF of the power or switching between the video sources. When the user performs (step SD12) the operation of tapping the power button B12 displayed on the touch panel 203, the control section 201 controls the short-range communication section 208 to transmit (step SD13) the character string of “power” made to correspond to the power button B12 to the projector 10C.

When the communication section 180C receives the character string of “power” transmitted from the information processing device 20, the control section 110C obtains the character string received by the communication section 180C. When the control section 110C obtains the character string of “power,” the control section 110C switches OFF the power to stop the supply of the power to the video processing section 150 and the projection section 140 in the case in which the power of its own device is in the ON state. Further, the control section 110C also stops (step SD14) the supply of the power to the communication section 180C since its own device is not provided with the network standby function. Since the power supply to the communication section 180C is stopped, the connection of the communication between the projector 10C and the information processing device 20 is cut. When the connection to the projector 10C is cut, the control section 201 controls the touch panel 203 so that the picture shown in FIG. 7 is displayed.

As described above, even if the information processing device 20 is connected to the projector 10C not provided with the server function, it is possible for the information processing device 20 to display the GUI image corresponding to the data of the GUI image provided in advance to the control application as a resource for the operations common to the projectors 10, and to operate the projector 10C using the wireless communication.

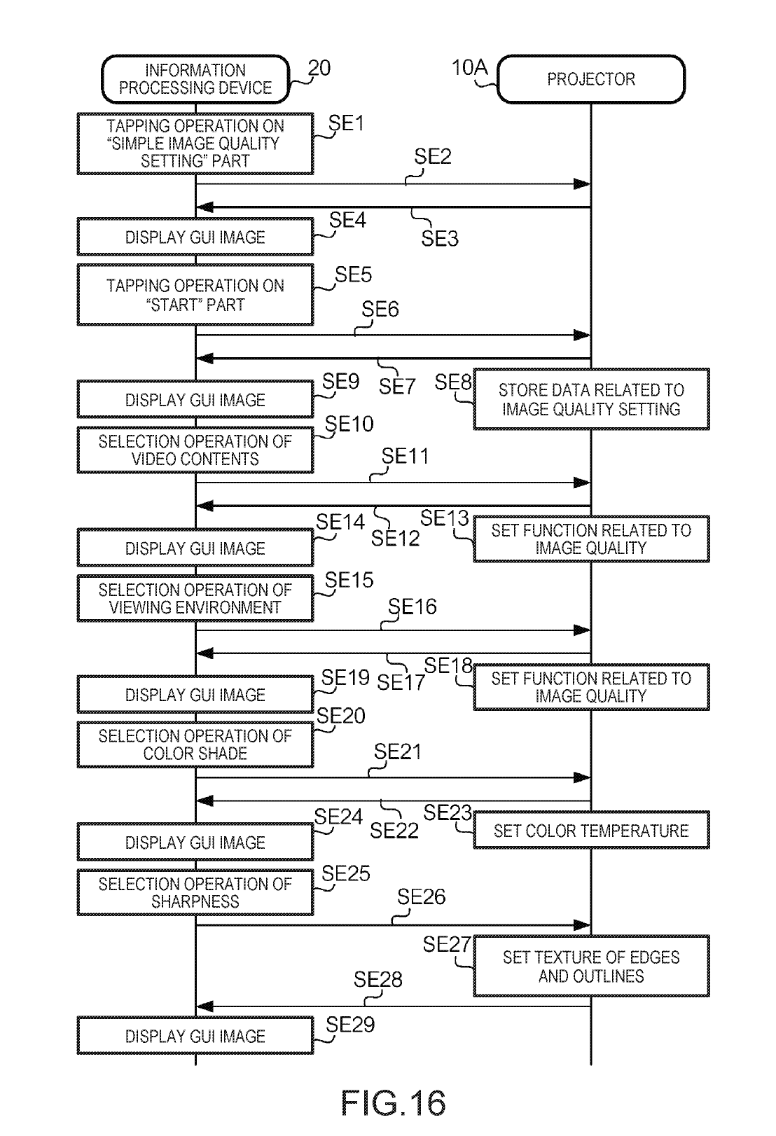

Then, an operation example in the case of interactively performing the image quality setting of the image to be projected by the projector 10 will be described using a sequence chart shown in FIG. 16. It should be noted that in the following description, an operation example will be described assuming the case in which the information processing device 20 is connected to the projector 10A.

When the user performs (step SE1) an operation of tapping a part corresponding to “SIMPLE IMAGE QUALITY SETTING” in the state in which the GUI image shown in FIG. 10 is displayed on the touch panel 203, the control section 201 obtains the character string described in the value attribute of the button tag corresponding to the part tapped in the HTML data of the GUI image. The control section 201 controls the short-range communication section 208 to transmit (step SE2) the character string thus obtained to the projector 10A. When the communication section 180A receives the character string transmitted from the information processing device 20, the control section 110A obtains the character string received by the communication section 180A, and then controls the communication section 180A to transmit (step SE3) the data of the GUI image corresponding to the character string thus obtained to the information processing device 20.

When the short-range communication section 208 receives the data of the GUI image transmitted from the projector 10A, the control section 201 obtains the data received by the short-range communication section 208. The control section 201 generates the GUI image in accordance with the data thus obtained, and then controls (step SE4) the touch panel 203 so that the GUI image thus generated is displayed.

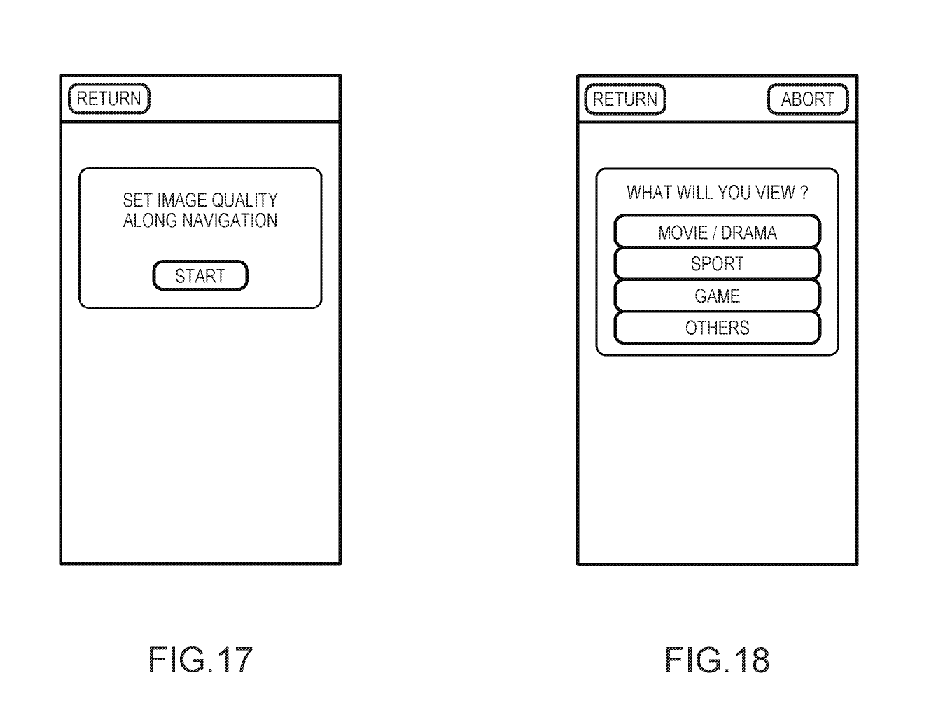

FIG. 17 is a diagram showing an example of the GUI image displayed here on the touch panel 203. When the user performs (step SE5) an operation of tapping a part corresponding to “START,” the control section 201 transmits (step SE6) a character string, which is described in the value attribute of the button tag corresponding to the part tapped in the HTML data of the GUI image, to the projector 10A, and then the projector 10A controls the communication section 180A to transmit (step SE7) the data of the GUI image, which corresponds to the character string thus transmitted, to the information processing device 20. Further, the control section 110A stores (step SE8) the data related to the setting of the image quality at that moment in the storage section 120A.

When the short-range communication section 208 receives the data of the GUI image transmitted from the projector 10A, the control section 201 generates the GUI image in accordance with the data received by the short-range communication section 208, and then controls (step SE9) the touch panel 203 so that the GUI image thus generated is displayed.

FIG. 18 is a diagram showing an example of the GUI image displayed here on the touch panel 203. Here, the user selects the video content to view. When the user performs (step SE10) an operation of tapping a part corresponding to either of “MOVIE/DRAMA,” “SPORT,” “GAME,” and “OTHERS,” the control section 201 transmits (step SE11) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A, and then controls the communication section 180A to transmit (step SE12) the data of the GUI image, which the information processing device 20 is made to display next, to the information processing device 20. Further, the control section 110A performs (step SE13) setting of the function related to the image quality in accordance with the character string thus obtained. For example, the control section 110A controls the video processing section 150 to set the function of frame interpolation to the ON state in the case in which the control section 110A has obtained the character string corresponding to the “MOVIE/DRAMA” part, and controls the video processing section 150 to set the function of the frame interpolation to the OFF state in the case in which the control section 110A has obtained the character string corresponding to the “SPORT” part or the character string corresponding to the “OTHERS” part. Further, in the case in which the control section 110A has obtained the character string corresponding to the “GAME” part, the control section 110A controls the video processing section 150 to set the function of the frame interpolation to the OFF state, the function of noise reduction to the OFF state, and the function of progressive conversion to the OFF state.

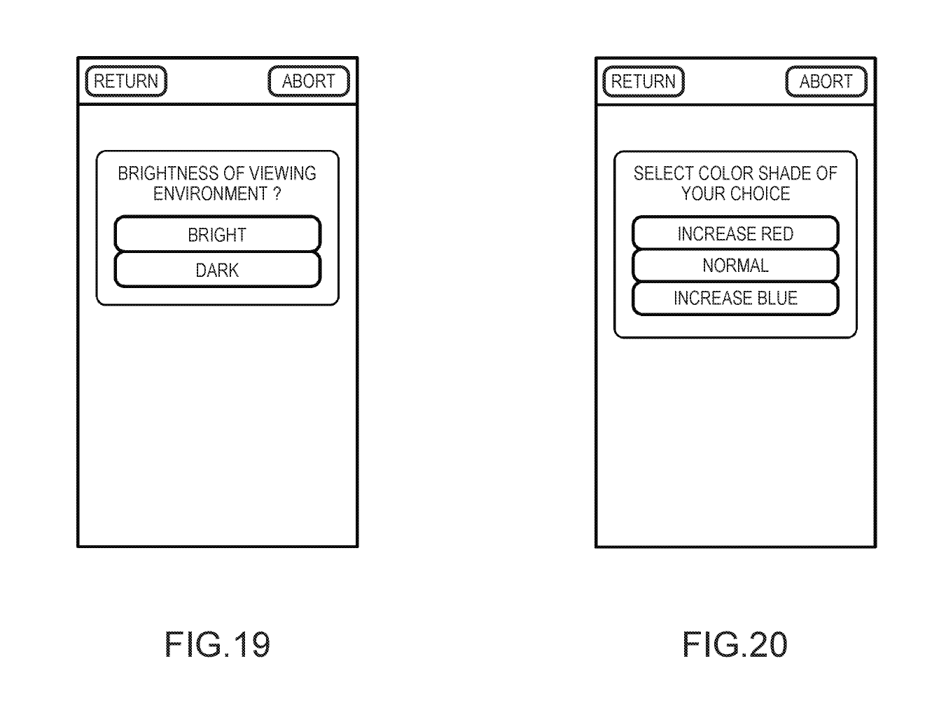

When the short-range communication section 208 receives the data of the GUI image transmitted from the projector 10A, the control section 201 generates the GUI image in accordance with the data received by the short-range communication section 208, and then controls (step SE14) the touch panel 203 so that the GUI image thus generated is displayed. FIG. 19 is a diagram showing an example of the GUI image displayed here on the touch panel 203. Here, the user selects the viewing environment. When the user performs (step SE15) an operation of tapping a part corresponding to “BRIGHT” or “DARK,” the control section 201 transmits (step SE16) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A, and then controls the communication section 180A to transmit (step SE17) the data of the GUI image, which the information processing device 20 is made to display next, to the information processing device 20. Further, the control section 110A performs (step SE18) setting of the function related to the image quality in accordance with the character string thus obtained. For example, the control section 110A sets a color mode to “DYNAMIC” in the case in which the control section 110A has obtained the character string corresponding to the “BRIGHT” part, and sets the color mode to “CINEMA” in the case in which the control section 110A has obtained the character string corresponding to the “DARK” part. The storage section 120A previously stores setting values of brightness, contrast, color depth, color shade, sharpness, and so on for each of the color modes, and the control section 110 obtains the setting values of the brightness, the contrast, the color depth, the color shade, the sharpness, and so on stored in advance in the storage section 120A so as to correspond to the color mode thus set to control the video processing section 150 with the setting values thus obtained.

When the short-range communication section 208 receives the data of the GUI image transmitted from the projector 10A, the control section 201 generates the GUI image in accordance with the data received by the short-range communication section 208, and then controls (step SE19) the touch panel 203 so that the GUI image thus generated is displayed. FIG. 20 is a diagram showing an example of the GUI image displayed here on the touch panel 203. Here, the user selects (step SE20) the color shade of the image to be projected. When the user performs an operation of tapping a part corresponding to either of “INCREASE RED,” “NORMAL,” and “INCREASE BLUE,” the control section 201 transmits (step SE21) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A, and then controls the communication section 180A to transmit (step SE22) the data of the GUI image, which the information processing device 20 is made to display next, to the information processing device 20. Further, the control section 110A controls the video processing section 150A in accordance with the character string thus obtained to perform (step SE23) setting of the color temperature of the image to be projected. For example, the control section 110A sets the color temperature to, for example, 5500 K in the case in which the control section 110A obtains the character string corresponding to the “INCREASE RED” part, sets the color temperature to 6500 K in the case in which the control section 110A obtains the character string corresponding to the “NORMAL” part, and sets the color temperature to 8000 K in the case in which the control section 110A obtains the character string corresponding to the “INCREASE BLUE” part. It should be noted that these values of the color temperature are illustrative only, and other values of the color temperature can also be adopted.

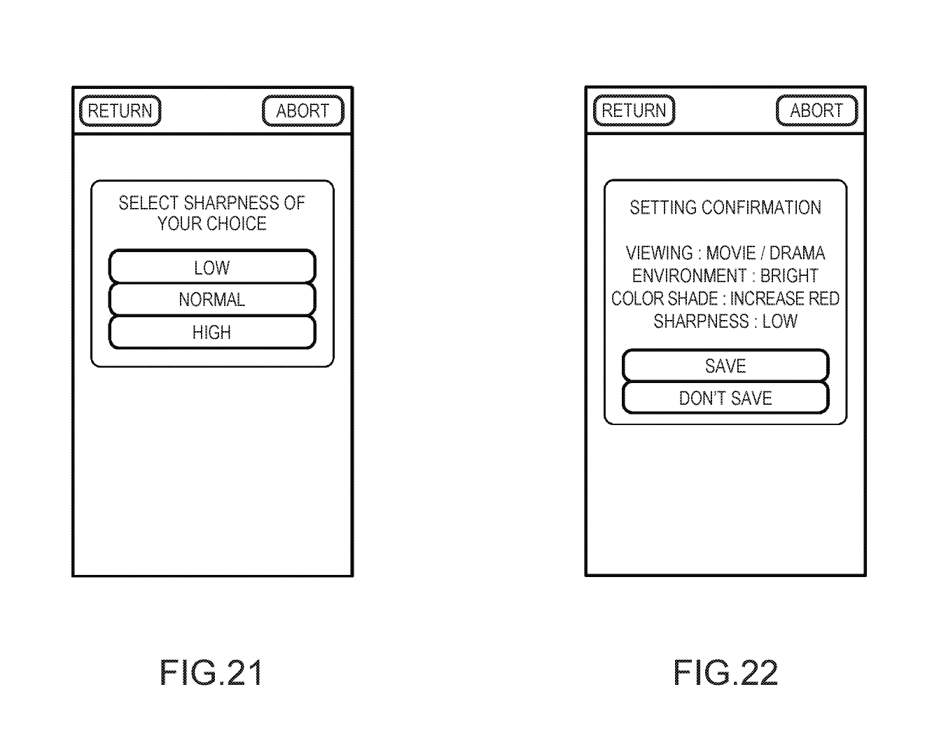

When the short-range communication section 208 receives the data of the GUI image transmitted from the projector 10A, the control section 201 generates the GUI image in accordance with the data received by the short-range communication section 208, and then controls (step SE24) the touch panel 203 so that the GUI image thus generated is displayed. FIG. 21 is a diagram showing an example of the GUI image displayed here on the touch panel 203. Here, the user selects (step SE25) the sharpness (the texture of edges and outlines) of the image to be projected. When the user performs an operation of tapping a part corresponding to either of “HIGH,” “NORMAL,” and “LOW,” the control section 201 transmits (step SE26) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A. The control section 110A controls the video processing section 150A in accordance with the character string thus obtained to perform (step SE27) setting of the degree of intensifying the edges and the outlines of the image to be projected. For example, the control section 110A sets the function of intensifying the edges and the outlines to the OFF state in the case in which the control section 110A obtains the character string corresponding to the “LOW” part, sets the function of intensifying the edges and the outlines to the ON state and the degree of intensifying to a degree corresponding to “NORMAL” in the case in which the control section 110A obtains the character string corresponding to the “NORMAL” part, and sets the function of intensifying the edges and the outlines to the ON state and the degree of intensifying to a degree corresponding to “HIGH” in the case in which the control section 110A obtains the character string corresponding to the “HIGH” part.

Then, the control section 110A generates the data of the GUI image for confirming the setting performed by the user based on the character strings transmitted from the information processing device 20 in accordance with the operations of the pictures shown in FIG. 18 through FIG. 21, and then transmits (step SE28) the data thus generated to the information processing device 20. When the short-range communication section 208 receives the data of the GUI image transmitted from the projector 10A, the control section 201 generates the GUI image in accordance with the data received by the short-range communication section 208, and then controls (step SE29) the touch panel 203 so that the GUI image thus generated is displayed.

FIG. 22 is a diagram showing an example of the GUI image displayed here on the touch panel 203. As shown in FIG. 22, the items selected by the user in the pictures shown in FIG. 18 through FIG. 21 are displayed on the touch panel 203, and it is possible for the user to confirm the content of the settings performed by the user him- or herself. The user looks at the image projected to confirm the image quality having been set. According to the present embodiment, since it is possible to interactively perform a variety of settings related to the image, and confirm the setting result by sight, it is possible to easily set the image quality of user's choice.

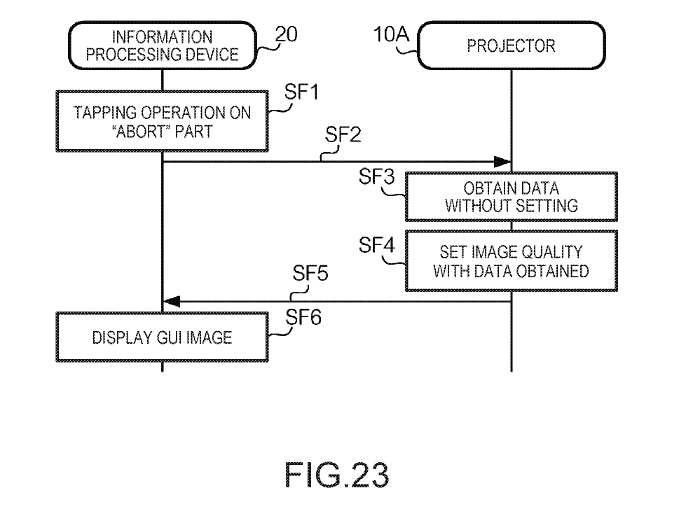

Then, an operation example in the case in which the image quality settings having been set are not stored, and an operation example in the case of storing the image quality settings having been set will be described using FIGS. 23 through 25.

In the case in which the image quality having been set is not the image quality of user's choice, the user performs (step SF1) an operation of tapping a part corresponding to “ABORT” located in the picture. When the operation is performed, the control section 201 transmits (step SF2) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A. In the case in which the character string thus obtained is the character string corresponding to the “ABORT” part, the control section 110A obtains (step SF3) the data stored in the step SE8 prior to the setting of the image quality from the storage section 120A. The control section 110A controls the video processing section 150A based on the data thus obtained to restore (step SF4) the image quality of the image to be projected to the state on which the settings shown in FIG. 17 through FIG. 20 are not performed.

When the process of the step SF4 ends, the control section 110A transmits (step SF5) the data of the GUI image shown in FIG. 10 to the information processing device 20. When the short-range communication section 208 receives the data of the GUI image transmitted from the projector 10A, the control section 201 generates the GUI image in accordance with the data received by the short-range communication section 208, and then controls (step SF6) the touch panel 203 so that the GUI image thus generated is displayed.

As described above, according to the present embodiment, in the case in which the image quality having interactively been set is not the image quality of user's choice, it is possible for the user to easily restore the image quality on which the setting is not performed.

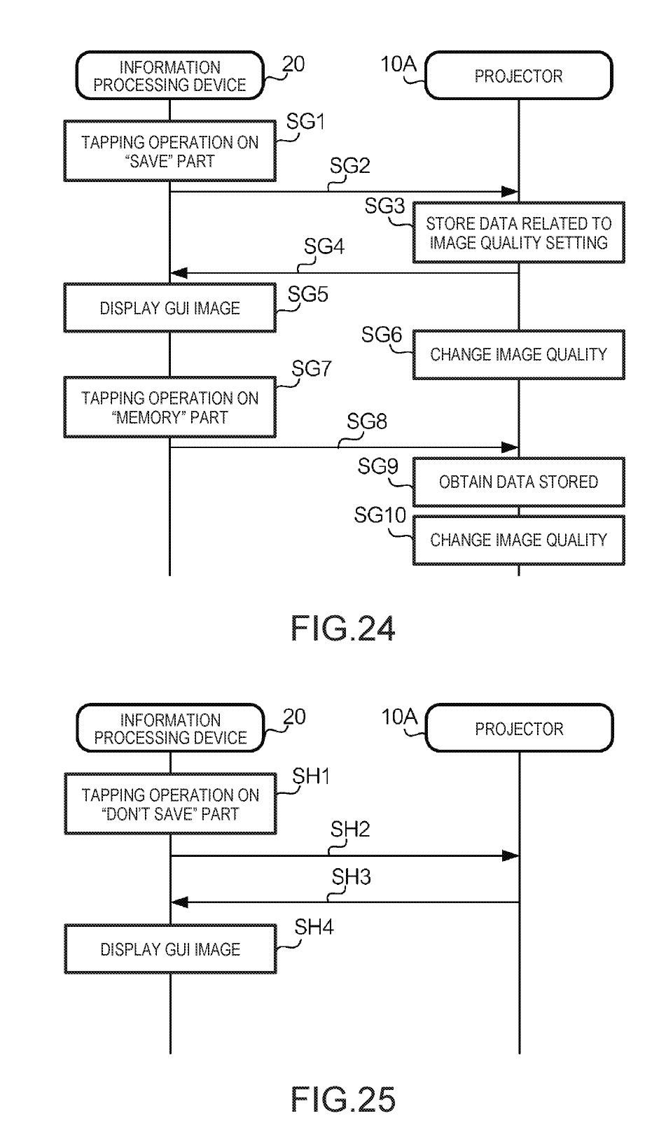

On the other hand, in the case in which the image quality having been set is the image quality of user's choice, the user selects whether or not the settings performed by him- or herself are to be stored in the projector 10A. In the case in which the user attempts to store the settings performed by him- or herself in the projector 10A, the user taps (step SG1 in FIG. 24) a part corresponding to “SAVE” on the touch panel 203 displaying the picture shown in FIG. 22. When the operation is performed, the control section 201 transmits (step SG2) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A. In the case in which the control section 110A obtains the character string corresponding to the “SAVE” part, the control section 110A stores (step SG3) the data related to the image quality setting performed on the pictures shown in FIG. 18 through FIG. 21 in the storage section 120A. When the storing of the data ends, the control section 110A transmits (step SG4) the data of the GUI image shown in FIG. 10 to the information processing device 20. When the short-range communication section 208 receives the data of the GUI image transmitted from the projector 10A, the control section 201 obtains the data received by the short-range communication section 208. The control section 201 generates the GUI image in accordance with the data thus obtained, and then controls (step SG5) the touch panel 203 so that the GUI image thus generated is displayed.

Subsequently, when the user operates the remote controller or the operation section 130A to change (step SG6) the image quality, the image quality different from the image quality set in the pictures shown in FIG. 17 through FIG. 20 is achieved. After the image quality is changed, when the user performs (step SG7) an operation of tapping a part where “MEMORY” is displayed in the touch panel 203 displaying the picture shown in FIG. 10, the control section 201 transmits (step SG8) a character string described in the value attribute of the button tag corresponding to the part tapped in the HTML data of the GUI image to the projector 10A. When the communication section 180A receives the character string transmitted from the information processing device 20, the control section 110A obtains the character string received by the communication section 180A. In the case in which the character string thus obtained is the character string corresponding to the “MEMORY” part, the control section 110A obtains (step SG9) the data stored in the step SG3 from the storage section 120A. The control section 110A controls the video processing section 150A based on the data thus obtained to change (step SG10) the image quality of the image to be projected to the image quality set when the data is stored in the step SG3.

As described above, according to the present embodiment, even in the case of changing the image quality from the image quality having interactively been set, it is possible to easily restore the image quality having interactively been set.

Further, in the case in which the user attempts not to store the settings performed by him- or herself in the projector 10A although the image quality thus set is the image quality of his or her choice, the user performs (step SH1) an operation of tapping a part corresponding to “DON′T SAVE” on the touch panel 203 displaying the picture shown in FIG. 22. When the operation is performed, the control section 201 transmits (step SH2) a character string described in the value attribute of the button tag corresponding to the part tapped in the HTML data of the GUI image to the projector 10A.

When the communication section 180A receives the character string transmitted from the information processing device 20, the control section 110A obtains the character string received by the communication section 180A. In the case in which the control section 110A obtains the character string corresponding to the “DON′T SAVE” part, the control section 110A does not store the data related to the image quality setting performed on the pictures shown in FIG. 18 through FIG. 21 in the storage section 120A, but transmits (step SH3) the data of the GUI image shown in FIG. 10 to the information processing device 20. When the short-range communication section 208 receives the data of the GUI image transmitted from the projector 10A, the control section 201 obtains the data received by the short-range communication section 208. The control section 201 generates the GUI image in accordance with the data thus obtained, and then controls (step SH4) the touch panel 203 so that the GUI image thus generated is displayed.

### Modified Examples

Although the embodiment of the invention is described hereinabove, the invention is not limited to the embodiment described above, but can be implemented in other various forms. For example, the invention can be implemented by modifying the embodiment described above as follows. It should be noted that the embodiment described above and the following modified examples can be implemented alone or in arbitrary combination.

Although in the embodiment described above, the information processing device 20 is connected to the projector 10, and then displays the identifier of the projector 10 thus connected in the display area A1, it is also possible to arrange that when the user inputs the identifier of another projector 10 in the textbox in which the identifier is displayed, the information processing device 20 changes the connection destination to the projector 10 having the identifier thus input.

In the invention, it is possible to transmit the image data of a still image or a moving image stored in the information processing device 20 from the information processing device 20 to the projector 10 as the connection destination, and it is also possible for the projector 10 to project the image (the content) represented by the image data transmitted from the information processing device 20. When transmitting the image data from the information processing device 20 and then projecting the image by the projector 10, it is also possible to dispose the GUI for selecting the image data in the display area A1, select the image data in accordance with the operation to the GUI, and then change the image to be projected.

Further, in this configuration, it is also possible to arrange that the image of the image data thus selected is displayed in the display area A1. When displaying the image of the image data selected in the display area A1, the size of the display area A1 is increases to a size larger than the size shown in FIG. 10.

Further, when changing the size of the display area A1, it is also possible that the information representing the size of the display area A1 is transmitted from the information processing device 20 to the projector 10, the projector 10 generates the data of the GUI image corresponding to the size thus transmitted to transmit the data thus generated to the information processing device 20, and the information processing device 20 displays the GUI image in the display area A2 based on the data of the GUI image thus transmitted.

In the invention, it is possible for the projector 10 to be powered OFF in the case in which the connection to the information processing device 20 has been established and then the connection is broken during the power ON state. Further, it is also possible for the projector 10 to be powered ON when the connection to the information processing device 20 is established in the case in which the network standby function is set to the enable state.

In the embodiment described above, it is also possible that the projector 10 includes the setting state of the network standby function in the function information when transmitting the function information to the information processing device 20, and the information processing device 20 performs the ON/OFF display of the checkbox in accordance with the setting state of the network standby function included in the function information when displaying the dialog box shown in FIG. 9.

In the invention, when the power of the projector 10 is switched OFF using the operation section 130 or the remote controller in the case in which the connection is established between the projector 10 in the power ON state and the information processing device 20, and the information processing device 20 displays the picture shown in FIG. 10, it is possible for the information processing device 20 to display the picture shown in FIG. 7 in accordance with the breakage of the connection.

Although in the embodiment described above, when interactively performing the setting of the image quality, the video processing section 150 is controlled to change the image quality at each of the moment when the picture to be viewed has been selected, the moment when the viewing environment has been selected, the moment when the color shade has been selected, and the moment when the sharpness has been selected, this configuration is not a limitation. For example, it is also possible to control the video processing section 150 to change the image quality in accordance with the items selected after completion of the selection of all of the items, namely the picture to be viewed, the viewing environment, the color shade, and the sharpness.

The color mode to be set in accordance with the viewing environment can be made different between the case in which the video signal represents a 2D image and the case in which the video signal represents a 3D image. Specifically, the control section 110 determines whether the video signal representing the image to be projected is a 2D-image signal or a 3D-image signal. For example, in the case in which the signal of the image to be projected is the 2D-image signal, it is also possible for the control section 110 to set the color mode to “BRIGHT CINEMA” if the user selects “BRIGHT” as the viewing environment, and set the color mode to “CINEMA” if the user selects “DARK,” and in the case in which the signal of the image to be projected is the 3D-image signal, it is also possible for the control section 110 to set the color mode to “3D DYNAMIC” if the user selects “BRIGHT” as the viewing environment, and set the color mode to “3D CINEMA” if the user selects “DARK.”

In the invention, in the case in which the projector 10 projects the image of the image data transmitted via the wireless LAN, the items of the image quality setting performed interactively can be made different from the items in the embodiment described above. For example, firstly, there is adopted a configuration in which the projection surface of the picture is selected from a “SCREEN,” a “WHITEBOARD,” and a “BLACKBOARD” in the first step. Here, in the case in which the “SCREEN” is selected, the brightness of the picture to be projected is set to a predetermined first brightness value, in the case in which the “WHITEBOARD” is selected, the brightness of the picture to be projected is set to a predetermined second brightness value, and in the case in which the “BLACKBOARD” is selected, the color mode is set to a predetermined mode.

Further, there is adopted a configuration in which the content of the picture to be projected is selected from a “BUSINESS DOCUMENT,” a “PHOTOGRAPH,” and a “WEB PAGE” in the next step. Here, in the case in which the “BUSINESS DOCUMENT” is selected, the color mode is set to “PRESENTATION,” and the sharpness is set to a predetermined setting value, in the case in which the “PHOTOGRAPH” is selected, the color mode is set to “DYNAMIC,” and in the case in which the “WEB PAGE” is selected, the color mode is set to “DYNAMIC,” and the sharpness is set to a predetermined setting value.

In the invention, it is also possible to arrange that the past operation history is stored when interactively setting the image quality, and the order of the items displayed in the pictures shown in FIG. 18 through FIG. 21 is changed based on the operation history stored. For example, it is also possible to arrange that in each of the pictures, the display positions of the selection items are displayed in the descending order in accordance with the number of times of the past election.

Although in the embodiment described above, it is arranged that the device for projecting the image is a liquid crystal projector using a transmissive liquid crystal panel, a projector using a reflective liquid crystal panel or a digital mirror device can also be adopted. Further, in the embodiment described above, the device for receiving the image data transmitted from the information processing device 20 and then displaying the image is not limited to the projector 10, but can also be, for example, a direct-view display device such as a liquid crystal television.

Although in the embodiment described above, the communication performed between the projector 10 and the information processing device 20 is the wireless communication compliant with the standard of IEEE 802.11, there can be adopted the communication compliant with other wireless communication standards such as the communication compliant with the standard of Bluetooth (registered trademark) or the communication using an infrared ray.

It is also possible for the control application to have a configuration having a table including the model names of the projectors 10 and the functions provided to the projectors 10 with the model names so as to correspond to each other. In the case of this configuration, it is possible for the information processing device 20 to obtain the model name from the projector 10, with which the connection has been established, to identify the functions of the projector 10 as the connection destination from the table and the model name thus obtained.

The programs realizing the functions related to the invention can be provided in the state of being stored in a computer readable recording medium such as a magnetic recording medium (e.g., a magnetic tape, a magnetic disk (e.g., a hard disk drive (HDD) or a flexible disk (FD)), an optical recording medium (e.g., an optical disk), a magneto-optical recording medium, or a semiconductor memory, and then installed in the respective devices. Further, it is also possible to download the programs via a communication network, and then install the programs in the respective devices.

What is claimed is:

1. A display device comprising:
a video signal acquisition unit adapted to obtain a video signal;
a display unit adapted to display an image represented by the video signal;
a communication unit adapted to establish connection to an information processing device to perform communication with the information processing device;
a transmission unit adapted to transmit information related to a plurality of interactive setting images having alternatives for setting an image quality of the image to the information processing device;
a reception unit adapted to receive the alternative selected by a user in the setting image in the information processing device; and
a setting unit adapted to set the image quality in accordance with the alternative received by the reception unit and a type of the video signal.

2. The display device according to claim 1, wherein
the image quality set by the setting unit is different between a case in which the type of the video signal is a 2D-image and a case in which the type of the video signal is a 3D-image even if the alternative received by the reception unit is the same.

3. The display device according to claim 1, wherein
the reception unit receives the alternative transmitted by the information processing device every time the selection of the alternative ends in one of the setting images, and
the setting unit sets the image quality in accordance with the alternative received every time the reception unit receives the alternative.

4. The display device according to claim 1, further comprising:
a storage unit adapted to store a history of the alternative selected for each of the setting images; and
a change unit adapted to change a content of the setting image in accordance with the history.

5. The display device according to claim 4, wherein
the change unit changes an order in which the alternatives are arranged.

6. A method of setting an image quality of a display device including a video signal acquisition unit adapted to obtain a video signal, a display unit adapted to display an image represented by the video signal, and a communication unit adapted to establish connection to an information processing device to perform communication with the information processing device, the method comprising:
transmitting information related to a plurality of interactive setting images having alternatives for setting an image quality of the image to the information processing device;
receiving the alternative selected by a user in the setting image in the information processing device; and
setting the image quality in accordance with the alternative received in the receiving the alternative selected by the user and a type of the video signal.
